(19) United States
(12) Patent Application Publication
(10) Pub. No.: US 2025/0182064 A1
(43) Pub. Date: Jun. 5, 2025

(54) METHOD AND SYSTEM FOR BUILDING REPAIR RECOMMENDATION SOLUTIONS USING GENERATIVE LANGUAGE MODELS AND FEW TRAINING EXAMPLES

(71) Applicant: HITACHI, Ltd., Tokyo (JP)

(72) Inventors: Xian Yeow LEE, Santa Clara, CA (US); Ahmed FARAHAT, Santa Clara, CA (US); Dipanjan GHOSH, Santa Clara, CA (US); Chetan GUPTA, Sunnyvale, CA (US)

(21) Appl. No.: 18/529,149

(22) Filed: Dec. 5, 2023

(51) Int. Cl. G06Q 10/20; G10L 15/183; G10L 15/22

(52) U.S. Cl. CPC G06Q 10/20; G10L 15/183; G10L 15/22

(57) ABSTRACT

Systems and methods described herein can involve, for receipt of a text input requesting a recommendation for an equipment based on underlying conditions, processing the text input with a fine-tuned generative language model (GLM) that is fined tuned to the equipment, the fine-tuned GLM configured to output raw text representative of the recommendation for the equipment based on the underlying conditions; and processing the output raw text into a recommendation mapping process configured to map the output raw text to one or more of: a checklist of recommendations conforming to end user standard, or a list of codes related to the recommendation for the equipment conforming to the end user standard.

### BACKGROUND

### Field

The present disclosure is generally directed to building repair solutions, and more specifically, to the use of generative language models for generating building repair solutions.

### Related Art

Diagnostics are a crucial aspect of the maintenance and repair process for any type of equipment or system. These diagnostics are typically made by experts or technicians who have the knowledge and expertise to identify the root cause of a problem and recommend the most effective solution. The process of diagnosing and executing a subsequent repair plan can help to extend the lifespan of equipment, reduce the likelihood of breakdowns and malfunctions, and improve the overall safety and performance of a system. Performing a successful diagnostic and deciding on an effective repair plan often involves a careful analysis of the equipment or system in question. This often requires a deep understanding of the design of the equipment, as well as a knowledge of industry best practices and safety standards.

Traditionally, the manual diagnostic process may involve an operator or technicians performing multiple manual tests on an equipment to identify the root cause of the problem and attempting to repair plan based on the test results. Alternatively, diagnostics are performed by collecting data from equipment and analyzing it to determine what type of repair is needed. The data is usually collected using sensors that are installed on the equipment. By analyzing data from the equipment, operators can detect patterns that indicate impending failure and can help prevent total equipment breakdowns and extend the life of the equipment. However, this traditional manual approach is time-consuming, and the success of a repair plan often depends on the technician's knowledge.

A more recent approach to assist the process of diagnosis and repair is Artificial Intelligence (AI) based repair recommendation systems. These systems perform repair recommendations by parsing through a corpus of historical text data, such as repair logs of previous diagnosis, the corresponding repairs performed, and attempting to match the current observations of the machinery to previous records. One related art example involves using structured data such as sequences or combination of fault codes that is emitted by the machinery. For example, fault codes may indicate a low flow rate in a cooling system which could be caused by a clogged filter, damaged impeller, or motor problem. The related art AI system would use the fault code as a reference to recommend one or more specific repair plans. Nevertheless, a major limitation of these related art AI-based recommendation systems is that they often require a lot of historical data to be trained.

A common approach for diagnostics and planning a course of repair is to manually cross-reference between knowledge in handbooks, and manuals as guidelines to attempt a specific repair for a given fault code or observed signals from sensor. This approach also often involves a significant amount of trial and error and would require a lot of time and effort.

In the related art, machine learning and deep learning models have also been developed as a strategy for repair recommendation to aid the overall diagnostic process. The models are given historical records of collected signals or in the form of structured data such as a database of fault codes and their corresponding repairs that were performed, and the model is trained to recommend the best repair recommendation given a new set of signals.

### SUMMARY

The related art implementations have several problems that remain unaddressed. Manual approaches result in ineffective repairs because it is often time-consuming, based on multiple trial-and-error efforts and requires the operators to be knowledgeable and trained to a certain extent in the particular repair domain. On the other hand, machine learning-based repair recommendations solutions are expensive to develop as historical records need to be collected and processed to train the model. Furthermore, the development of machine learning models is also time-consuming as many iterations of hyperparameter tuning are often required. Additionally, interaction of the operator with either manual or machine learning (ML) based repair recommendations are often sub-optimal as it requires the operator to learn the manuals in detail.

Example implementations involve systems and methods that adapt a generative language model (GLM) to recommend repairs for an equipment based on a set of user complaints received by the user along with a set of fault codes from that equipment. The example implementations described herein can require fewer labeled examples of historical repairs to fine-tune a GLM to a specific equipment in comparison to the related art. The example implementations also map the GLM raw output to a set of valid repair actions.

Example implementations described herein can involve a training strategy that fine-tunes a GLM on domain-specific documents in an unsupervised way if the public information on the Internet does not contains information about the target equipment.

The example implementations can also involve the fusion of complaints from equipment user, fault codes from equipment and additional information about equipment attributes to improve repair recommendation. The example implementations described herein are flexible enough to be able to take as input a varying amount of information. In addition, the example implementations described herein are user-friendly and can allow the user to interact with the solution in a natural language interface using multiple modalities.

Example implementations described herein can also be easily generalizable to different categories of users such as technicians, who may prefer more specific repair recommendations and users who may prefer more general recommendations. The example implementations described herein are also capable of implicitly handling inputs with same meaning but with different lexicons.

Aspects of the present disclosure can involve a method, which can include for receipt of a text input requesting a recommendation for an equipment based on underlying conditions. processing the text input with a fine-tuned generative language model (GLM) that is fined tuned to the equipment, the fine-tuned GLM configured to output raw text representative of the recommendation for the equipment based on the underlying conditions; and processing the output raw text into a recommendation mapping process configured to map the output raw text to one or more of: a checklist of recommendations conforming to end user standard, or a list of codes related to the recommendation for the equipment conforming to the end user standard.

Aspects of the present disclosure can involve a system, which can include for receipt of a text input requesting a recommendation for an equipment based on underlying conditions, means for processing the text input with a fine-tuned generative language model (GLM) that is fined tuned to the equipment, the fine-tuned GLM configured to output raw text representative of the recommendation for the equipment based on the underlying conditions; and means for processing the output raw text into a recommendation mapping process configured to map the output raw text to one or more of: a checklist of recommendations conforming to end user standard, or a list of codes related to the recommendation for the equipment conforming to the end user standard.

Aspects of the present disclosure can involve an apparatus, which can include a processor, configured to, for receipt of a text input requesting a recommendation for an equipment based on underlying conditions, process the text input with a fine-tuned generative language model (GLM) that is fined tuned to the equipment, the fine-tuned GLM configured to output raw text representative of the recommendation for the equipment based on the underlying conditions; and process the output raw text into a recommendation mapping process configured to map the output raw text to one or more of: a checklist of recommendations conforming to end user standard, or a list of codes related to the recommendation for the equipment conforming to the end user standard.

Aspects of the present disclosure can involve a computer program, which can include instructions involving, for receipt of a text input requesting a recommendation for an equipment based on underlying conditions, processing the text input with a fine-tuned generative language model (GLM) that is fined tuned to the equipment, the fine-tuned GLM configured to output raw text representative of the recommendation for the equipment based on the underlying conditions; and processing the output raw text into a recommendation mapping process configured to map the output raw text to one or more of: a checklist of recommendations conforming to end user standard, or a list of codes related to the recommendation for the equipment conforming to the end user standard. The computer program and instructions can be stored on a non-transitory computer readable medium and executed by one or more processors.

### BRIEF DESCRIPTION OF DRAWINGS

FIG. 1 illustrates an example implementation for training a generative language model, in accordance with an example implementation.

FIG. 2 illustrates an example flow for technicians with text-based input, in accordance with an example implementation.

FIG. 3 illustrates an example flow for users with audio-based input, in accordance with an example implementation.

FIG. 4 illustrates an example overall flow, in accordance with an example implementation.

FIG. 5 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

Example implementations described herein involve systems and methods to improve repair recommendation processes by fine-tuning a GLM that handles natural language interactions with few examples and mapping it to a set of valid recommendations. The example implementations can involve the flow as follows.

As an initial step, a pre-trained generative language model is initialized and fine-tuned on a few historical records and corresponding repair recommendation to improve the accuracy of the GLM. As generative language models are trained on a large corpus of relevant text, these GLM typically do not require a lot of new data to be collected to train from scratch. Intuitively, the model has already learnt the semantic meanings of most words and only fine-tuning is required to align the model towards a customer's specific domain. This advantage directly translates to cost savings to customers as they do not need to collect a lot of data to train these GLMs. Additionally, if a customer has a separate use-case, the same GLM easily be fine-tuned on the new use case as well using a few data examples. After fine-tuning the GLM, for any equipment, the user may use one or more of any data acquisition system to collect the equipment's fault codes and specific equipment attributes such as make, model, year, and so on.

The user converts any structured, non-textual data into a natural language description. After converting the non-textual data into text form, the operator may combine it with any textual fault codes if available. In an example implementation, there is the process of converting non-textual data into a natural language description use so as to have multiple templates ready. Such example implementations can convert the non-textual data into textual format, where the templates themselves could be proposed by another GLM.

Using the combined textual data, the user may input the description about the equipment, fault codes alongside with any specific queries into the GLM interface.

The query can be formatted in a natural language format as long as it contains all the necessary information about the equipment, fault codes and sensor data. Alternatively, the user may also directly query using voice and have a speech-to-text model convert the speech to text.

Upon querying the GLM, the GLM will typically return a passage of free text involving repair recommendations. A mapping module is then used to map the free text to a set of valid repair action.

Additionally, the operator may also re-word the query in another way if the operator is unsure about the response and may also ask follow-up questions based on the initial response of the GLM

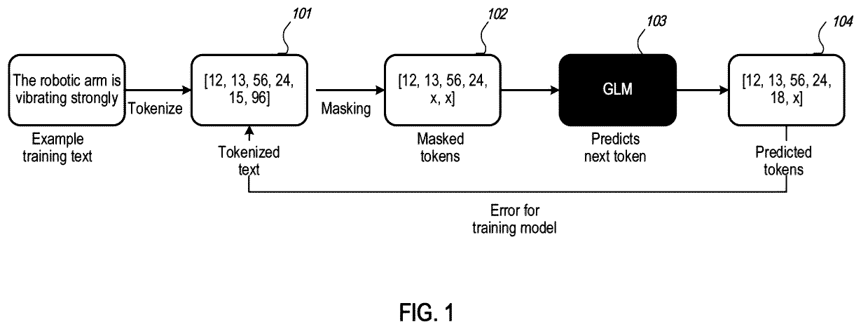

FIG. 1 illustrates an example implementation for training a generative language model, in accordance with an example implementation. Generative language models are a class of autoregressive language models that represent a probability distribution over a sequence of tokens. In general, a generative language model is represented by a neural network and the training can be summarized as follows as illustrated in FIG. 1.

Tokenize a large corpus of text data 101: this process converts text into numerical values, called tokens.

Masked tokens 102: Given a sequence of tokens, a portion of the tokens are hidden (masking) and the model is trained to predict the most probable next token.

Predicting next token 103: The token predicted by the model is then added to the sequence of tokens and the process repeats with the model predicting the most probable next token again.

Since the generative language model is trained on a masked portion of the text, no additional labelling effort is needed as the model can be trained on any given large corpus of text by just programmatically tokenizing and masking some part of the text for the model to learn to predict the next word. Note that after pre-training, the GLM can also be further fine-tuned on additional supervised task.

With regards to fine-tuning for domain specific applications, if it turns out that the GLM is intended to be used in a very specific, niche domain, it is possible that the original corpus of public data might not contain enough information in that domain for the GLM to perform well in downstream applications. In this scenario, the GLM can also be fine-tuned in an unsupervised manner on another corpus of domain specific data (but not necessarily on a specific downstream task) to further improve the capability of the GLM. For example, a GLM that is trained on public data might not be very proficient in fault codes (e.g., automotive), and fine tuning the GLM on a corpus of data related to the domains (e.g., automotive) can further improve the capabilities on downstream tasks.

With regards to fine-tuning for customer specific applications, since the GLM was originally pre-trained on a large corpus of data some of which contains public information about the maintenance and repair in general and specific types of these equipment, only a few additional examples are required to further fine-tune the GLM to a specific customer's preference as a lot of the basic knowledge has already been encoded in the first stage of training. For example, the GLM would already have learnt the mapping between fault codes and embeddings of repair recommendation. The fine-tuning might to adapt to the embeddings to the specific language/jargon/technical terms of the additional examples provided by the user. In general, the GLM can be fine-tuned using multiple approaches such as additional supervised training or unsupervised training or a combination of them.

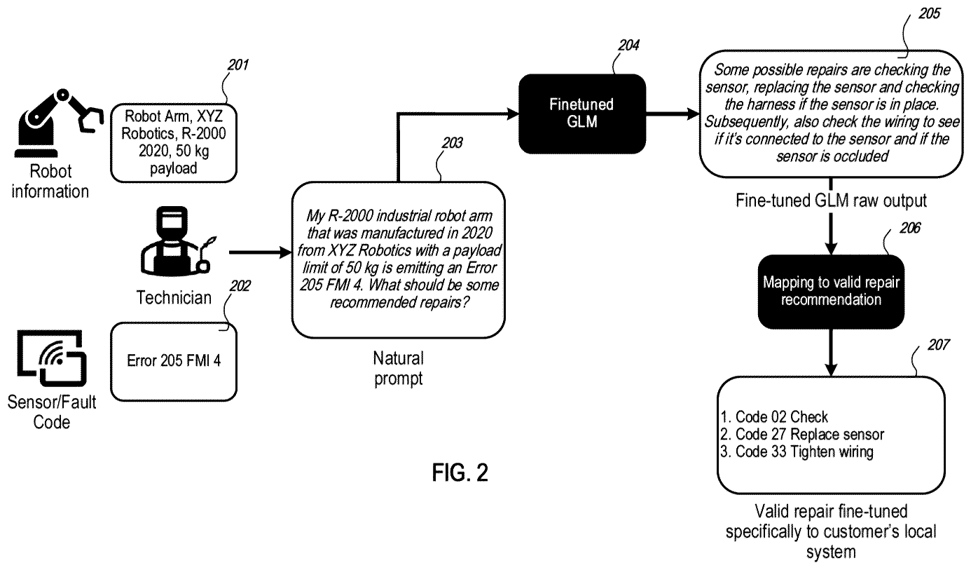

FIG. 2 illustrates an example flow for technicians with text-based input, in accordance with an example implementation. In the example flow of FIG. 2, a technician manages an industrial robotic arm and has corresponding technical specification information 201. The technician has received a sensor/fault code 202. Through the example implementations described herein, the technician can provide a text-based input prompt 203 indicating the robotic arm information and the sensor/fault code received. The text prompt is processed through the finetuned GLM 204, which produces raw output 205. The raw output 205 needs to be converted to valid repair recommendations so it is mapped at 206 accordingly. The output by the example implementations can involve a sequence of repair codes or a list of repair codes 207 that are used by the technician to conduct maintenance on the robotic arm.

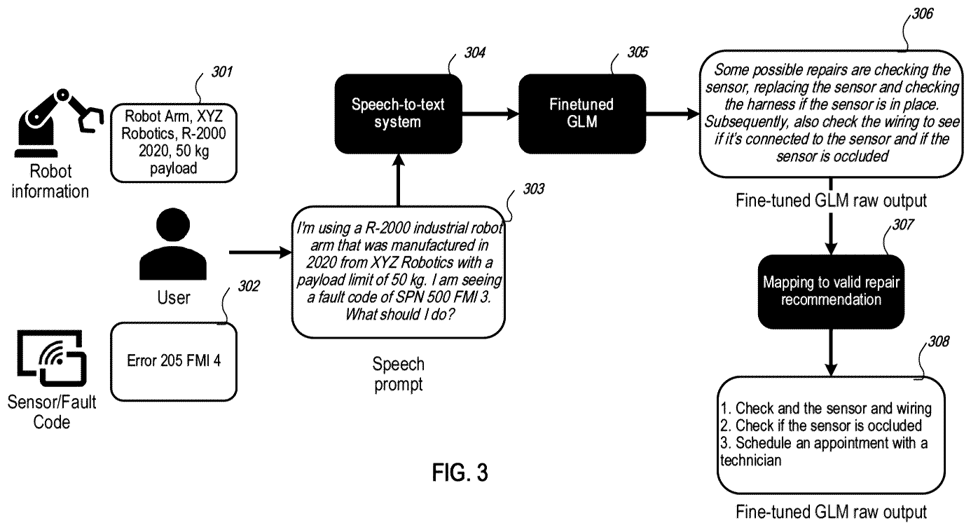

FIG. 3 illustrates an example flow for end-users with audio-based input, in accordance with an example implementation. In the example implementation of FIG. 3, the user of the robotic arm provides a speech prompt 303, based on the sensor/fault code 302 received and the information regarding the robotic arm 301. The audio input is processed by a speech-to-text system 304 and then processed through the finetuned GLM 305 to produce raw output 306. The raw output 306 is then mapped to valid repair recommendations 307 to provide a list or a sequence of recommendations 308 that the user can use to determine the next course of maintenance.

The recommendation mapping process can be generated in accordance with any desired implementation. For example, the recommendation mapping process can be generated through training a classifier configured to output the codes in response to the output raw text based on a temporal state of the equipment. This classifier can be trained against historical repairs and historical temporal states of the equipment, as well as against historical symptoms so that the classifier can output the repairs (e.g., codes) in response to a given temporal state and symptoms as derived from input. The recommendation process can also be configured with a summarizer configured to summarize the codes into the checklist of recommendations, and can also be configured to provide a measure of similarity to known recommendations. As outputting raw codes as illustrated in 207 of FIG. 2 may not be desirable to the user, the codes can be converted into a summary involving a checklist of recommendations based on the codes through any desired implementation. In addition, if there is no exact solution, the recommendation process may output a measure of similarity to the known recommendations to indicate to the user how similar the recommendations are to the present situation of the equipment.

Depending on the desired implementation, the flow of FIGS. 2 and 3 can also involve a pre-processing layer before the finetuned GLM to pre-process the input from the user before providing the input to the finetuned GLM. Such a pre-processing layer can be configured to remove edge cases, vagueness, and implicitness from the text input, and/or formulate the text input into a specific problem and repair case of the equipment for input into the fine-tuned GLM. In an example implementation, the input from the user can be pre-processed to identify a problem and repair case based on natural text processing or otherwise to identify the problem and repair case. Based on pre-processing, vagueness or implicitness (e.g., text that is not relevant according to the pre-processing layer) can be removed, as well as edge cases that are identified. The pre-processing layer can be configured in accordance with any desired implementation to facilitate the appropriate input to the finetuned GLM.

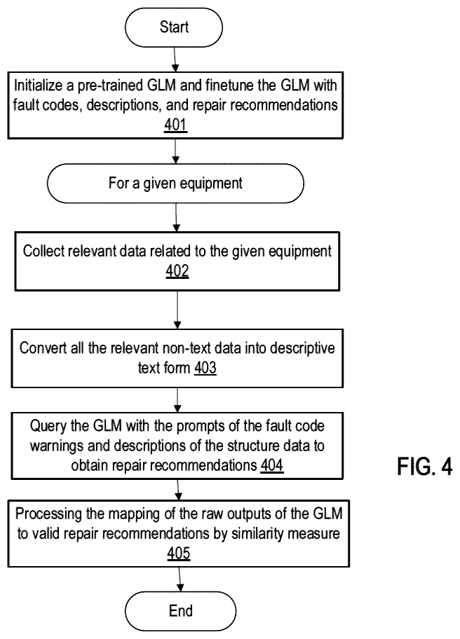

FIG. 4 illustrates an example overall flow, in accordance with an example implementation. At first, at 401, a pre-trained GLM is initialized and finetuned with examples of previous fault codes, corresponding descriptions, and the corresponding repair recommendations. At 402, for a given equipment, all related data to the equipment are collected, such as, but not limited to, fault code warnings, operation logs, and other details. At 403, the relevant non-text data (e.g., fields in tables related to units, models, and make) are converted into a descriptive text form. Through this process, the GLM can be finetuned to produce raw text repair recommendations from both structured and unstructured data. At 404, the GLM can then be queried with the prompts of the fault code warnings and descriptions of the structure data to obtain the raw text repair recommendations.

At 405, a system can be attached to the raw outputs of the GLM to ensure that the repair recommendations are valid by mapping the raw output to one or more nearest sets of repair recommendations based on a measure of similarity as determined in accordance with the desired implementation.

Through the example implementations described herein, the operators of industrial equipment can directly query the GLM for predictive maintenance recommendations, without the need of deep knowledge, manual cross-referencing or trial and error approaches.

These GLM are trained on a large corpus of knowledge, thus a huge amount of data is not needed to train the model from scratch and can be trained in using only a few examples in a few-shot fashion. Furthermore, if additional data exist, these can also be used to further finetune the GLM to improve the performance.

Further, it is much easier for operators to interact with the GLM in a natural language interface, rather than learning a specialized software.

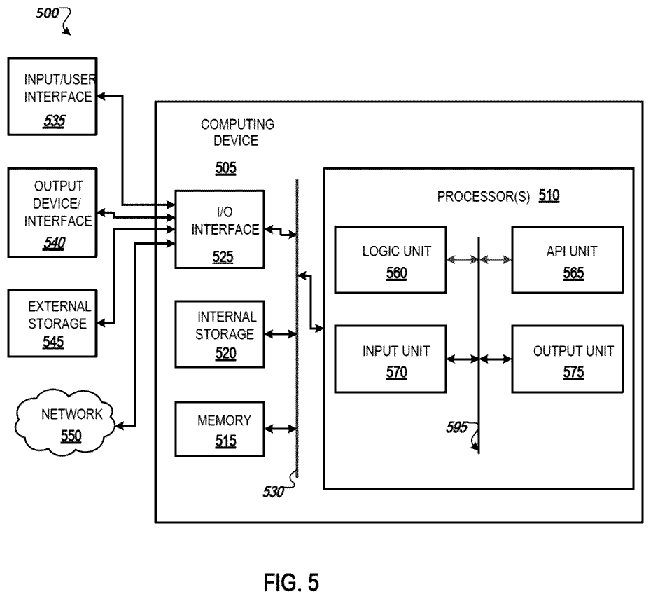

FIG. 5 illustrates an example computing environment with an example computer device suitable for use in some example implementations. Computer device 505 in computing environment 500 can include one or more processing units, cores, or processors 510, memory 515 (e.g., RAM, ROM, and/or the like), internal storage 520 (e.g., magnetic, optical, solid-state storage, and/or organic), and/or IO interface 525, any of which can be coupled on a communication mechanism or bus 530 for communicating information or embedded in the computer device 505. IO interface 525 is also configured to receive images from cameras or provide images to projectors or displays, depending on the desired implementation.

Computer device 505 can be communicatively coupled to input/user interface 535 and output device/interface 540. Either one or both of the input/user interface 535 and output device/interface 540 can be a wired or wireless interface and can be detachable. Input/user interface 535 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 540 may include a display, television, monitor, printer, speaker, braille, or the like. In some example implementations, input/user interface 535 and output device/interface 540 can be embedded with or physically coupled to the computer device 505. In other example implementations, other computer devices may function as or provide the functions of input/user interface 535 and output device/interface 540 for a computer device 505.

Examples of computer device 505 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 505 can be communicatively coupled (e.g., via IO interface 525) to external storage 545 and network 550 for communicating with any number of networked components, devices, and systems, including one or more computer devices of the same or different configuration. Computer device 505 or any connected computer device can be functioning as, providing services of, or referred to as a server, client, thin server, general machine, special-purpose machine, or another label.

IO interface 525 can include but is not limited to, wired and/or wireless interfaces using any communication or IO protocols or standards (e.g., Ethernet, 802.11x, Universal System Bus, WiMAX, modem, a cellular network protocol, and the like) for communicating information to and/or from at least all the connected components, devices, and network in computing environment 500. Network 550 can be any network or combination of networks (e.g., the Internet, local area network, wide area network, a telephonic network, a cellular network, satellite network, and the like).

Computer device 505 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 505 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python. Perl, JavaScript, and others).

Processor(s) 510 can execute under any operating system (OS) (not shown), in a native or virtual environment. One or more applications can be deployed that include logic unit 560, application programming interface (API) unit 565, input unit 570, output unit 575, and inter-unit communication mechanism 595 for the different units to communicate with each other, with the OS, and with other applications (not shown). The described units and elements can be varied in design, function, configuration, or implementation and are not limited to the descriptions provided. Processor(s) 510 can be in the form of hardware processors such as central processing units (CPUs) or in a combination of hardware and software units.

In some example implementations, when information or an execution instruction is received by API unit 565, it may be communicated to one or more other units (e.g., logic unit 560, input unit 570, output unit 575). In some instances, logic unit 560 may be configured to control the information flow among the units and direct the services provided by API unit 565, the input unit 570, the output unit 575, in some example implementations described above. For example, the flow of one or more processes or implementations may be controlled by logic unit 560 alone or in conjunction with API unit 565. The input unit 570 may be configured to obtain input for the calculations described in the example implementations, and the output unit 575 may be configured to provide an output based on the calculations described in example implementations.

Processor(s) 510 can be configured to execute a method or computer instructions involving, for receipt of a text input (e.g., 203 of FIG. 2) requesting a recommendation for an equipment based on underlying conditions, processing the text input with a fine-tuned generative language model (GLM) that is fined tuned to the equipment, the fine-tuned GLM (e.g., 204 of FIG. 2) configured to output raw text (e.g., 205 of FIG. 2) representative of the recommendation for the equipment based on the underlying conditions; and processing the output raw text into a recommendation mapping process (e.g., 206 of FIG. 2) configured to map the output raw text to one or more of: a checklist of recommendations conforming to end user standard, or a list of codes related to the recommendation for the equipment conforming to the end user standard as illustrated at 207 or 308 of FIG. 2 and FIG. 3, respectively. Depending on the desired implementation, the conformation to the end user standard can involve a valid recommendation that is understandable to the end user based on their own set of base codes or base lists. In example implementations, because the set of base codes or base lists should be known to the end user, the end user can then feed the recommendation to an automated repair process so that the repair process can be conducted on the equipment in an automated manner depending on the desired implementation. In another example implementation, the recommendation is provided through the repair screen or through the user device so that the user can then perform the repairs indicated by the recommendation.

Depending on the desired implementation, the text input can be converted from audio input from the end user as illustrated in FIG. 3.

Processor(s) 510 can be configured to execute the method or instructions as described above, and further involve processing the text input with a pre-processing layer configured to remove edge cases, vagueness, and implicitness from the text input and is further configured to formulate the text input into a specific problem and repair case of the equipment for input into the fine-tuned GLM.

Depending on the desired implementation, the fine-tuned GLM can be curated with structured and unstructured data related to the equipment as described with respect to 402 and 403 of FIG. 4.

Depending on the desired implementation, the recommendation mapping process can involve a classifier configured to output the codes in response to the output raw text based on a temporal state of the equipment, and a summarizer configured to summarize the codes into the checklist of recommendations, and can also be configured to provide a measure of similarity to known recommendations as described with respect to 405 of FIG. 4.

Depending on the desired implementation, the checklist of recommendations conforming to the end user standard can include repairs as illustrated at 308 of FIG. 3; wherein the list of codes related to the recommendation for the equipment conforming to the end user standard comprises repair codes as illustrated at 207 of FIG. 2.

Depending on the desired implementation, the checklist of recommendations or the list of codes is output according to a sequence to conduct the recommendations or the list of codes. In example implementations, if there is a required sequence as determined by the finetuned GLM or mapping to valid repair recommendation, then the recommendations can be output in sequence for execution by an automated repair system or for display on a user interface on a repair or user device.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
for receipt of a text input requesting a recommendation for an equipment based on underlying conditions:
processing the text input with a fine-tuned generative language model (GLM) that is fined tuned to the equipment, the fine-tuned GLM configured to output raw text representative of the recommendation for the equipment based on the underlying conditions; and
processing the output raw text into a recommendation mapping process configured to map the output raw text to one or more of: a checklist of recommendations conforming to end user standard, or a list of codes related to the recommendation for the equipment conforming to the end user standard.

2. The method of claim 1, wherein the text input is converted from audio input from the end user.

3. The method of claim 1, further comprising processing the text input with a pre-processing layer configured to remove edge cases, vagueness, and implicitness from the text input and is further configured to formulate the text input into a specific problem and repair case of the equipment for input into the fine-tuned GLM.

4. The method of claim 1, wherein the fine-tuned GLM is curated with structured and unstructured data related to the equipment.

5. The method of claim 1, wherein the recommendation mapping process comprises a classifier configured to output the codes in response to the output raw text based on a temporal state of the equipment, and a summarizer configured to summarize the codes into the checklist of recommendations and is configured to provide a measure of similarity to known recommendations.

6. The method of claim 1, wherein the checklist of recommendations conforming to the end user standard comprises repairs; wherein the list of codes related to the recommendation for the equipment conforming to the end user standard comprises repair codes.

7. The method of claim 1, wherein the checklist of recommendations or the list of codes is output according to a sequence to conduct the recommendations or the list of codes.

8. A non-transitory computer readable medium, storing instructions for executing a process, the instructions comprising:
for receipt of a text input requesting a recommendation for an equipment based on underlying conditions:
processing the text input with a fine-tuned generative language model (GLM) that is fined tuned to the equipment, the fine-tuned GLM configured to output raw text representative of the recommendation for the equipment based on the underlying conditions; and
processing the output raw text into a recommendation mapping process configured to map the output raw text to one or more of: a checklist of recommendations conforming to end user standard, or a list of codes related to the recommendation for the equipment conforming to the end user standard.

9. The non-transitory computer readable medium of claim 8, wherein the text input is converted from audio input from the end user.

10. The non-transitory computer readable medium of claim 8, the instructions further comprising processing the text input with a pre-processing layer configured to remove edge cases, vagueness, and implicitness from the text input and is further configured to formulate the text input into a specific problem and repair case of the equipment for input into the fine-tuned GLM.

11. The non-transitory computer readable medium of claim 8, wherein the fine-tuned GLM is curated with structured and unstructured data related to the equipment.

12. The non-transitory computer readable medium of claim 8, wherein the recommendation mapping process comprises a classifier configured to output the codes in response to the output raw text based on a temporal state of the equipment, and a summarizer configured to summarize the codes into the checklist of recommendations and is configured to provide a measure of similarity to known recommendations.

13. The non-transitory computer readable medium of claim 8, wherein the checklist of recommendations conforming to the end user standard comprises repairs; wherein the list of codes related to the recommendation for the equipment conforming to the end user standard comprises repair codes.

14. The non-transitory computer readable medium of claim 8, wherein the checklist of recommendations or the list of codes is output according to a sequence to conduct the recommendations or the list of codes.

15. An apparatus, comprising:
a processor, configured to, for receipt of a text input requesting a recommendation for an equipment based on underlying conditions:
process the text input with a fine-tuned generative language model (GLM) that is fined tuned to the equipment, the fine-tuned GLM configured to output raw text representative of the recommendation for the equipment based on the underlying conditions; and
process the output raw text into a recommendation mapping process configured to map the output raw text to one or more of: a checklist of recommendations conforming to end user standard, or a list of codes related to the recommendation for the equipment conforming to the end user standard.
